(19) United States
(12) Patent Application Publication
(10) Pub. No.: US 2002/0107725 A1
(43) Pub. Date: Aug. 8, 2002

(54) Scholarship award method

(76) Inventors: Matthew W. Hickey, Portland, OR (US); James H. Wolfston, West Linn, OR (US); Raymond L. Price, Portland, OR (US)

Correspondence Address: MICHAEL O. SCHEINBERG, P.O. BOX 164140, AUSTIN, TX, 78716-4140, US

(21) Appl. No.: 10/003,471

(22) Filed: Oct. 31, 2001

Related U.S. Application Data
(60) Provisional application No. 60/245,778, filed on Nov. 1, 2000.

(51) Int. Cl. G06F 17/60

(52) U.S. Cl. 705/12

(57) ABSTRACT

Anyone having Internet access can contact a scholarship award web site and nominate a student for a scholarship. Scholarships are awarded on the basis of a voting criterion, such as the number of votes cast at the web site, thereby motivating large numbers of supports of nominees to visit the web site.

This application claims priority from U.S. Provisional Patent Application 60/245,776, which is hereby incorporated by reference.

### TECHNICAL FIELD OF THE INVENTION

The present invention relates to the field of academic scholarships, and, in particular, to a method of awarding scholarships on-line to increase traffic at a college-related Internet site.

### BACKGROUND OF THE INVENTION

Regardless of the method by which web sites produce income, all sites need to attract new and returning visitors to be successful. A primary method of encouraging visitors to visit a site is to provide information at the site that is useful to the visitors. For example, the Mach25™ scholarship site produced by CollegeNET, Inc., the assignee of the present invention, allows students to search dynamically through a large number of scholarships to locate ones for which the student may be eligible. A site, such the Mach25™ scholarship site, that is easy to use and provides searchable, comprehensive, up-to-date scholarship information will entice students to visit. Because there are many sites that offer useful information to students, it can be difficult for a site to distinguish itself from others offering similar services.

One method of attracting visitors to a site is to provide them with a chance to obtain something valuable. For example, visitors can enter a competition for something of value, such as a scholarship. Academic scholarships are commonly awarded based on a variety of criteria including financial need, academic achievement, and athletic achievement. CollegeNET, Inc. offers a scholarship competition at its site, the scholarship being awarded based on an essay contest. Although such competitions do increase the number of visitors, the number of students interested in entering such contests is limited. These contest do not, therefore, attract large numbers of new visitors.

### SUMMARY OF THE INVENTION

An object of the present invention is to provide a method and apparatus for awarding scholarships, the method using the Internet and increasing the number of visits to a college-related Internet site using the system.

The present invention attracts new and returning visitors to a college-related Internet site. In accordance with the invention, any college student or prospective college student may be nominated for a scholarship award. Visitors to the Internet site then vote for one or more of the scholarship nominees. Periodically, one or more scholarship nominees are selected, based upon the number of votes received, for scholarship awards.

The present invention motivates a large number of people to visit the web site because winning an award scholarship requires not just a single visit by the nominee, but visits by many voters. In the prior art, only the individual student applying for the reward or scholarship is required to visit a web site.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and the advantages thereof, reference is now made to the following descriptions taken in conjunction with the accompanying drawings, in which:

FIG. 1 shows a diagram of the hardware used to implement a preferred embodiment of the present invention.

FIG. 2 is a flowchart showing the steps of nominating a student for an academic scholarship in accordance with a preferred embodiment of the present invention.

FIG. 3 is a flowchart showing the steps of voting for a student for an academic scholarship in accordance with a preferred embodiment of the present invention.

### DETAILED DESCRIPTION OF THE PREFERRED EMBODIMENTS

A preferred embodiment of the present invention allows anyone having Internet access and a web browser to nominate a student for a scholarship at a web site operating in accordance with the invention. One or more scholarships are then awarded based upon the number of votes the nominee receives from visitors to the site.

Because the award is based on the number of electronic votes cast at the web site, winning typically requires a large of number of supporters of the nominee to visit the web site. The invention thus provides incentive for both students seeking scholarships and for their supporters to visit the web site.

The scholarship award method is particularly well adapted for group efforts and can allow a school, community, etc. to work together to win a scholarship for a particularly deserving individual, thereby significantly increasing traffic at the college-related Internet site.

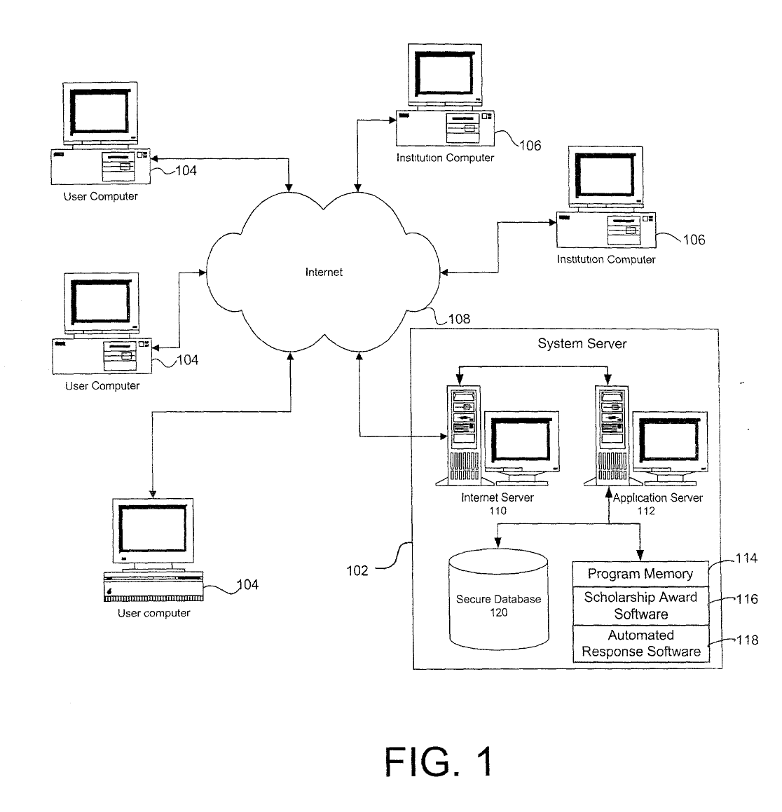

FIG. 1 shows the hardware for implementing one embodiment of the present invention. The hardware includes a system server 102, multiple user computers 104, and multiple institution computers 106 communicatively connected to one another through the portion of the Internet 108 known as the World Wide Web (the Web). System server 102 typically comprises multiple computers, including an Internet server 110 and an application server 112, which has program memory 114 for, among other things, storing and executing a scholarship award software 116. Application server 112 also executes automated response software 118 for automatically responding to the content of posted electronic forms or e-mail, such as the software described in U.S. patent application for a “Automatic Data Transmission in Response to Content of Electronic Forms Satisfying Criteria,” which is filed concurrently with the present application, assigned to the assignee of the present invention, and hereby incorporated by reference. Application server 112 is also operably connected to a secure database 120, which stores nominee data, voter data, and vote data.

Both Internet server 110 and application servers 112 are computers, such as Sun Solaris UltraSparc Servers, that respectively execute Web server software for coordinating communications with visitors to a scholarship award Web site and scholarship award software 116 for implementing a scholarship award system in accordance with the present invention. Scholarship award information and forms transferred from server 102 are typically formatted in a hypertext mark-up language (HTML) and can include text, programs, graphics, video, and audio portions. Parts of the scholarship award program may be implemented using a common gateway interface (CGI) program specified by a form (e.g., HTML form received from a user via a scholarship award web site) to provide a scholarship voting or nomination session. The CGI program is preferably written in Perl, C, C++, Java, or another language that supports CGI. The CGI program accesses database 120, which includes information about nominee, voters, and votes used by the scholarship award software. Database 120 is preferably a relational database that is accessed using a structured query language through a database management system, such as DB2 from IBM. It should be noted, however, that the invention is not limited to any particular implementation technology. The hardware and software implementation details are expected to change as computer technology evolves.

System server 102 is preferably operated by a scholarship award service provider. The scholarship award service provider can host multiple scholarship award contests that are sponsored by sponsoring institutions, such as universities or financial institutions. Multiple institution computers 106, operated by institutions can communicate with the scholarship award service provider over the Internet. Multiple scholarship competitions may be simultaneously provided at the same or different web pages through system server 102. Each institution sponsoring a scholarship award page can customize its page, so that the visitors are unaware that the page is hosted by the scholarship award service provider and not by the sponsoring institution itself.

A typical one of user computers 104 comprises a personal computer, such as an Intel Pentium-based or Advanced Micro Devices Athlon-based personal computer using a Windows-based operating system and running a commercially available Web Browser, such as Netscape Navigator or Internet Explorer. In a preferred embodiment, user computers can use an older, text-based browser, because any processing, such as error checking, is preferable performed at server, rather than at the client browser.

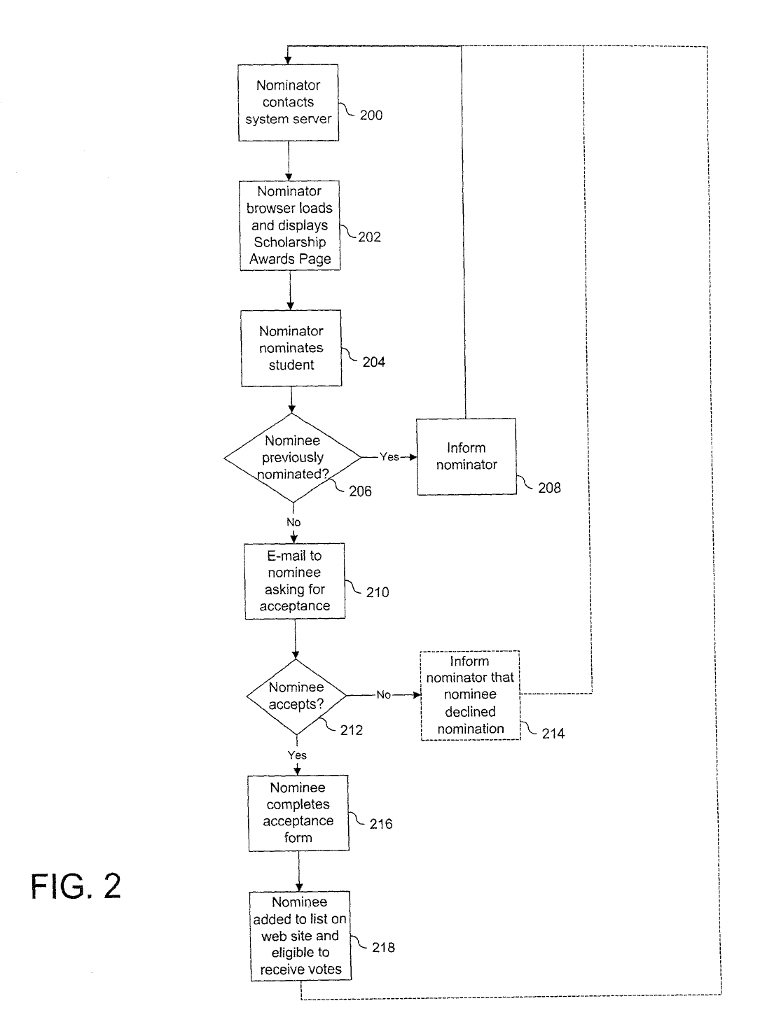

FIG. 2 describes the steps for nominating an individual student for a scholarship in a preferred embodiment of the invention. The steps of FIG. 2 will be performed multiple times by multiple nominators, at least once for each nominee, as indicated by the broken line from the last step to the first. In step 200, a nominator using one of user computers 104 contacts server 102, typically by following a link displayed on a college-related web page. For example, the link may be on a university's financial aid web page or the link may be on the page of a college-related portal, such as the one operated by CollegeNET, Inc., that helps students locate a suitable college, complete an on-line application, and locate appropriate scholarships. The nominator may also access the web site by typing the web address, or URL, into his or her web browser or recalling a stored address.

Once contact is established between one of user computers 104 and system server 102, the nominator's web browser loads a Scholarship Award Program web page from server 102 and displays the web page to the nominator in step 202. The Scholarship Award Program web page preferably allows the nominator to view the current status of the scholarship competition and provides forms to nominate a student for a scholarship and to vote for a previously nominated student. These activities may be available directly on the Scholarship Award Program web page or may be on pages linked from the Scholarship Award Program web page.

In step 204, the nominator nominates a student for a scholarship. In nominating a student, the nominator is required to provide the student's name and e-mail address. A student may nominate himself or herself. In step 206, server 102 checks to see whether the nominee was previously nominated and is already listed on the voting page. If so, system server 102 sends the nominator a message in step 208 stating that the nominee is already in the contest and providing a URL at which the nominator can vote for the nominee.

If the nominee is not already listed, system server 102 in step 210 sends the nominee an e-mail message congratulating him on his nomination and asking if he accepts the nomination. The e-mail to the nominee can be generated automatically as described in a U.S. Pat. App. for a “Automatic Data Transmission in Response to Content of Electronic Forms Satisfying Criteria.”

If the nominee declines the nomination in step 212, the nominator is informed in step 214 and the nominee is not listed on the voting page. The nominator may then nominate one or more other students if he chooses.

If the nominee accepts the nomination in step 212, he completes a nomination acceptance form in step 216 confirming his or her identity. The nomination acceptance form can optionally request additional information that is not required for the scholarship competition. Such information may include, for example, the name of the school that the nominee is currently attending, the colleges in which the nominee is interested, preferred courses of study, etc.

In step 218, after posting the nomination acceptance form, the nominee is added to the list of nominees displayed on the voting web page. The voting web page may conspicuously list the current top nominees (e.g., top 10, 20, or 50), and the remaining nominee may be accessible in a less conspicuous location, such as in a scrolled list window by name, number of votes, home state, or other sort criteria.

The broken line from step 218 back to step 200 indicates that the nominator can nominate additional students or other nominators can nominate other students. It will be understood that the same student may be nominated by different nominators using variations on the nominee's name or using different nominee e-mail addresses. In such cases, the nominees may receive more than one nomination acceptance form. Software running on system server 102 can check for apparent duplicate nominees using the more detailed information returned from the nominee acceptance form with the goal that each student nominee appears only once on the list of the nominees.

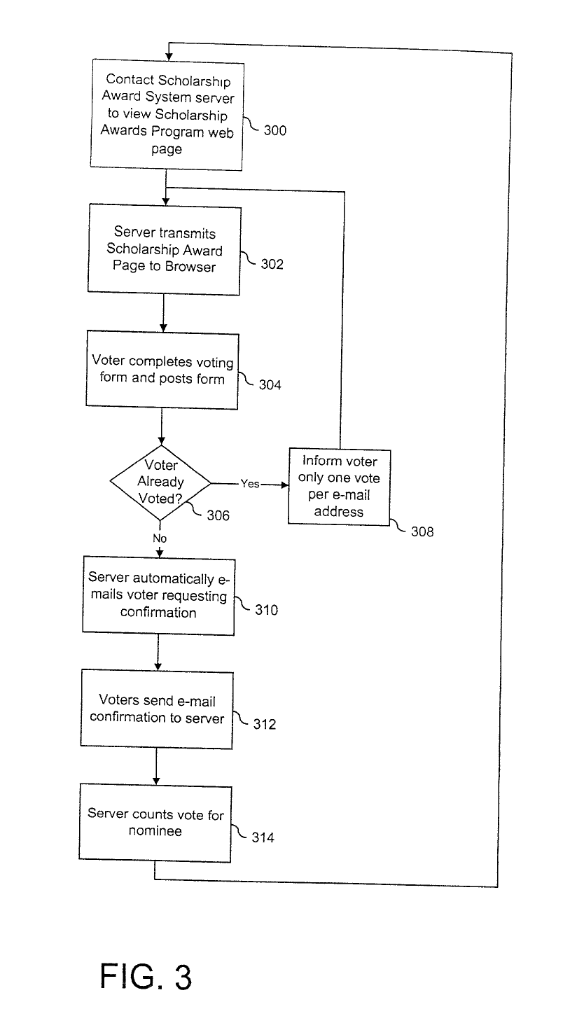

FIG. 3 shows the steps of voting for a student for an academic scholarship in accordance with a preferred embodiment of the present invention. The steps of FIG. 3 will therefore be carried out multiple times, as indicated by the broken line from the last step to the first. In step 300, a voter, who may be the same as the nominator, contacts system server 102 over the Internet using one of user computers 104. In step 302, system server 102 transmits to user computer 104 the Scholarship Award Program web page to be displayed on the users web browser.

The Scholarship Award Program web page includes, either on the page itself or through a link, a list of nominees as described above and a form for voting for a nominee. For the privacy and safety of the nominees, the nominees are preferably not identified by information that would permit a stranger to otherwise contact the nominee. Voters typically learn from others outside the system the identity of the student before voting. For example, a high school administration may inform members of its community that the “John S. of Nashville, Tennessee” listed on the voting page is their student, John Smith, and encourage members of its community to vote for him.

In step 304, the voter votes by completing and posting the voting form. The voting software at server 102 allows each voter to vote only once for each scholarship nominee. To this end, in one preferred embodiment, the voter indicates his vote in step 304 using the voting form at the web site and provides his email address (i.e., a voter email address) for confirmation of the vote. The voter is notified, by a notice on the voting form or by a page that displays after the voting form is posted, that his vote will not be counted until he responds to an e-mail confirmation.

In step 306, system server 102 compares the voter's e-mail address received on the posted voting form to e-mail addresses in memory of voters that have already voted for that nominee. If the voter has already voted for that nominee, system server 102 transmits in step 308 a page to the voter's web browser informing the voter that he has already voted for that nominee and that only one vote per nominee is permitted. The voter is then returned to the Scholarship Award Page to review the vote totals or vote for a different student.

If the e-mail address entered on the voting form by the voter does not correspond to the email address stored in database 120 as the e-mail address of someone who has already voted, system server 102 automatically generates in step 310 a vote confirmation e-mail and sends it to the voter at the voter's listed email address. The vote confirmation e-mail thanks the voter for voting and requests that the voter reply to confirm the vote so that it may be counted. If a voter used a false e-mail address, the confirmation e-mail will be not be received by the voter and the vote will not be counted.

In step 312, the voter replies to the vote confirmation e-mail. The reply is received at an address associated with system server 102. System server 102 preferably verifies that the voter reply did in fact come from the e-mail address entered in the voting form. If it did not, server 102 will disregard the vote. If the e-mail reply was received from the correct e-mail address, the vote is then tallied in step 314 as a vote for the indicated scholarship nominee.

Although individuals having multiple e-mail addresses would be able to bypass the control and vote more than once, the number of duplicate votes is expected to be insignificant in comparison to the overall number of votes cast. Additional checks on the voter identity could be performed if desired.

After the completion of a voting period, the nominee or nominees having the greatest numbers of votes are awarded scholarships. Awards are typically made periodically. For example, in one embodiment, the nominees with the top three vote counts at the end of each month are awarded scholarships. Winning nominees can be removed from the system. The remaining nominees can remain on the system, or all nominees can be removed and the voting restarted. If nominees remain on the system for voting in the next voting period, votes older than a specified age, for example, six months, may expire and be removed from the vote count for that nominee. Nominees may also be removed from the system either after a specified period of time, after a specified period of inactivity, or upon request of the nominee. Scholarships are awarded by payment directly to a financial aid office specified by the winning nominees.

The scholarships can be awarded after the occurrence of any event, not just the passage of prespecified time. For example, a scholarship could be granted to the first or students who accumulate a prespecified number of votes.

Although the preferred embodiment of the invention is implemented using an Internet Web site, the invention is not limited to any particular type of computer or computer network.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method of attracting visitors to a college-related web site, comprising:
providing a form for use in nominating a scholarship recipient nominee;
nominating a scholarship recipient nominee;
contacting the nominee to confirm that the nominee accepts the nomination;
providing a form for voting for a nominee;
posting the form to vote for a nominee;
confirming the vote using electronic mail; and
awarding a scholarship to the nominee satisfying a voting criterion.

2. The method of claim 1 in which awarding a scholarship to the nominee satisfying a voting criterion includes awarding a scholarship to the nominee having the most votes within in a prespecified time period.

3. The method of claim 1 in which awarding a scholarship to the nominee satisfying a voting criterion includes awarding a scholarship to the first nominee nominated.

4. The method of claim 1 in which awarding a scholarship to the nominee satisfying a voting criterion includes awarding a scholarship to the first nominee to receive a predetermined number of votes.

5. A method of awarding scholarships using a site on a global computer network, comprising:
nominating multiple nominees for a scholarship;
voting for the multiple nominees; and
awarding the scholarship to the nominee satisfying a voting criterion.

6. The method of claim 5 further comprising transmitting a confirmation of the vote by electronic mail.

7. The method of claim 5 in which voting for multiple nominees comprises each one of multiple voters submitting an electronic voting form or electronic communication.

8. The method of claim 7 in which voting for multiple nominees further comprises a voter transmitting an electronic mail message to confirm a vote for one of the multiple nominees.

9. The method of claim 8 further comprising verifying that the voter has not previously voted for the one of the multiple nominees, thereby preventing the voter from casting more than one vote for any nominee.

10. The method of claim 5 in which any individual having access to the global computer network can nominate a nominee.

11. The method of claim 5 further comprising posting a list of nominee identifiers to identify the nominee to voters, the identifier not providing the real name or address of the nominee.

12. The method of claim 11 further comprising seeking consent of the nominee before posting the nominee's name on the list.

13. A computer readable media including instructions for executing the step of claim 1.
